(19) United States
(12) Patent Application Publication
(10) Pub. No.: US 2010/0303244 A1
(43) Pub. Date: Dec. 2, 2010

(54) METHOD AND MOBILE DEVICE FOR DELIVERING AUDIO DATA OVER SHORT RANGE WIRELESS COMMUNICAITON CHANNELS

(75) Inventors: Sang Don KIM, Hwaseong-si (KR); Wan Gyu KIM, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/791,298

(22) Filed: Jun. 1, 2010

(30) Foreign Application Priority Data
Jun. 1, 2009 (KR) 10-2009-0047970

(51) Int. Cl. H04H 20/88

(52) U.S. Cl. 381/2; 455/41.3

(57) ABSTRACT

A method and mobile device for delivering individual audio streams multiplexed in an audio data to at least one audio device through corresponding radio channels. The method includes establishing a communication channel with each of at least one audio device, receiving multiplexed audio data, extracting individual audio streams from the multiplexed audio data, allocating at least one of the individual audio streams to one or more communication channels, and transmitting the at least one of the individual audio streams to one or more of the at least one audio device through respective one or more communication channels.

### PRIORITY

This application claims the benefit under 35 U.S.C. §119(a) of a Korean patent application filed on Jun. 1, 2009 in the Korean Intellectual Property Office and assigned Serial No. 10-2009-0047970, the entire disclosure of which is hereby incorporated by reference.

### BACKGROUND OF THE INVENTION

1. Field of the Invention:

The present invention relates to short range wireless communications. More particularly, the present invention relates to a method and mobile device for delivering individual audio streams multiplexed in audio data to at least one audio device through independent radio channels.

2. Description of the Related Art:

With a rapid increase in popularity, a mobile phone has become a necessity. The mobile phone has been developed from a voice-only device to a multimedia device supporting various supplementary services and functions. Recently, various short range wireless communication technologies are developed for low cost and low power communications. Bluetooth is an example of short range wireless communication technology for low cost and low power wireless communication between devices. The Bluetooth technology allows a user to perform hands free communication with a Bluetooth-enabled audio device and secure voice communication even when an audio/video file plays in a host device (i.e., mobile phone).

If a multiplexed audio stream is input to the host device or a media file stored in a multiplexed audio format is playing in the host device, the host device can deliver one main audio data among an individual audio data multiplexed audio stream to the audio device. Accordingly, even when multiple Bluetooth audio devices are connected to the host device, individual audio devices receive only the same audio data (set as the main audio). This means that, even when a multiplexed sound service content or a multichannel audio content is played in the host device, it is impossible for the user to select one of the multiplexed audio streams or feel a stereophonic feeling intended by multichannel audio.

Therefore, a need exists for a method and mobile device for delivering multiple audio streams multiplexed in audio data to different audio devices.

### SUMMARY OF THE INVENTION

An aspect of the present invention is to address at least the above-mentioned problems and/or disadvantages and to provide at least the advantages described below. Accordingly, an aspect of the present invention is to provide a method for independently delivering individual audio streams multiplexed in audio data to different audio devices.

Another aspect of the present invention is to provide a method for delivering at least one of a plurality of audio streams multiplexed in audio data to target audio devices through corresponding short range wireless communication links.

Still another aspect of the present invention is to provide a mobile device for selectively delivering individual audio streams multiplexed in audio data to at least one audio device.

In accordance with an aspect of the present invention, an audio data delivery method for a mobile device in a short range wireless communication network is provided. The method includes establishing a communication channel with each of at least one audio device, receiving multiplexed audio data, extracting individual audio streams from the multiplexed audio data, allocating at least one of the individual audio streams to one or more communication channels, and transmitting the at least one of the individual audio streams to one or more of the at least one audio device through respective one or more communication channels.

In accordance with another aspect of the present invention, a mobile device is provided. The device includes a short range wireless communication unit for establishing a radio channel with each of at least one audio device, a demultiplexer for demultiplexing multiplexed audio data into individual audio streams, and a control unit for allocating at least one of the individual audio stream to one or more radio channels and for transmitting the at least one of the individual audio streams to one or more of the at least one audio device through corresponding one or more radio channels.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a multichannel audio delivery system according to an exemplary embodiment of the present invention;

FIG. 2 is a block diagram illustrating a configuration of a Bluetooth-enabled mobile device according to an exemplary embodiment of the present invention;

FIG. 3 is a flowchart illustrating a multichannel audio deliver method for a mobile device in a short range wireless communication network according to an exemplary embodiment of the present invention;

FIG. 4 is a flowchart illustrating an individual audio data selection process of FIG. 3 according to an exemplary embodiment of the present invention;

FIG. 5 is a flowchart illustrating an individual audio data selection process of FIG. 3 according to an exemplary embodiment of the present invention;

FIG. 6A is a diagram illustrating a screen displaying a name list of individual audio data according to an exemplary embodiment of the present invention;

FIG. 6B is a diagram illustrating a screen displaying a name list of Bluetooth audio devices according to an exemplary embodiment of the present invention; and

FIG. 6C is a diagram illustrating a screen displaying a list of an individual audio data-audio device mapping table according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, the term “multiplexed audio data” denotes audio data multiplexed with multiple audio streams. The multiplexed audio data may be created by a multiplexer which may divide a link or a channel into multiple sub-channels for transmitting and receiving individual audio streams constituting the audio data.

In the following description, the term “audio stream” denotes audio data demultiplexed from the multiplexed audio data by a demultiplexer.

Although the following description is directed to Bluetooth technology, exemplary embodiments of the present invention may be applied to other short range wireless communication technologies, such as Infrared Data Association (IrDA) and ZigBee that may establish wireless communication channels between at least two devices.

In the following description, the mobile device may be any of a mobile phone, a Portable Multimedia Player (PMP), a Personal Digital Assistant (PDA), a Smartphone, a Moving Pictures Expert Group-1 Audio Layer 3 (MP3) player, and the like that may play audio/video files and support short range wireless communication.

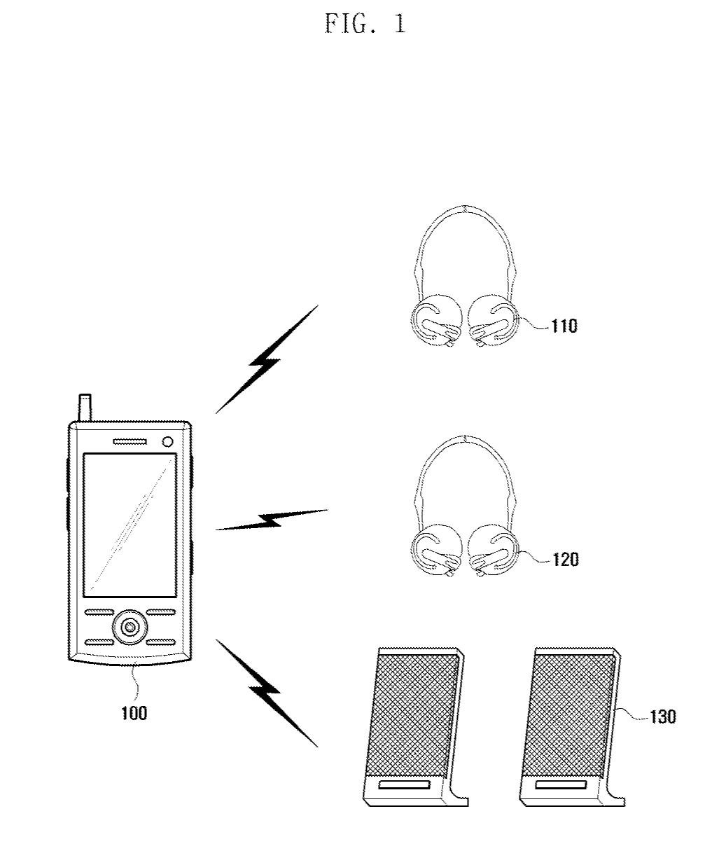

FIG. 1 is a diagram illustrating a multichannel audio delivery system according to an exemplary embodiment of the present invention.

Referring to FIG. 1, the multichannel audio deliver system includes a mobile device 100 and a plurality of audio devices 110, 120, and 130. Each of the mobile device 100 and audio devices 110, 120, and 130 is provided with a Bluetooth module. The audio devices 110, 120, and 130 may connect to the mobile device 100 simultaneously. Bluetooth operates on a 2.4 GHz Industrial Scientific Medical (ISM) band that may be used without a license. In order to prevent interference between devices, a guard band is used at a lower band edge (e.g., 2.0 MHz) and at an upper band edge (e.g., 3.5 MHz). Bluetooth uses frequency hopping spread spectrum technology.

The mobile device 100 broadcasts an inquiry message to induce the audio devices 110, 120, and 130 to return an inquiry response message including an address (BD_ADDR) and clock information, and requests the audio devices to return the inquiry response message to transmit its device name. The audio device which received the device name request message transmits its device name to the mobile device 100. If the device names of the audio devices 110, 120, and 130 are received, the mobile device 100 displays the device names on a screen while waiting for the user to select an audio device. If an audio device is selected by the user, the mobile device establishes a connection with the selected audio device through a paging process.

In an exemplary implementation, the mobile device 100 establishes the connection with the audio devices 110, 120, and 130 in a sequential order.

In a case where the audio device has been connected previously, the mobile device 100 skips the inquiry process and performs the paging process directly. Also, if the mobile device 100 has information on the audio device, even though there is no previous connection history with the audio device, the inquiry process may be skipped.

The audio devices 110, 120, and 130 may be configured in various manners according to their types. A Bluetooth headset such as the audio devices 110 and 120 may be configured with a receiver for processing received audio data and a microphone, and a Bluetooth speaker such as the audio device 130 may be configured with only a receiver but not a microphone.

The mobile device 100 transmits the audio data to the audio devices 110, 120, and 130 through respective Bluetooth links. The audio devices 110, 120, and 130 processes the audio data received from the mobile device 100 to output the audio data in an audible sound wave.

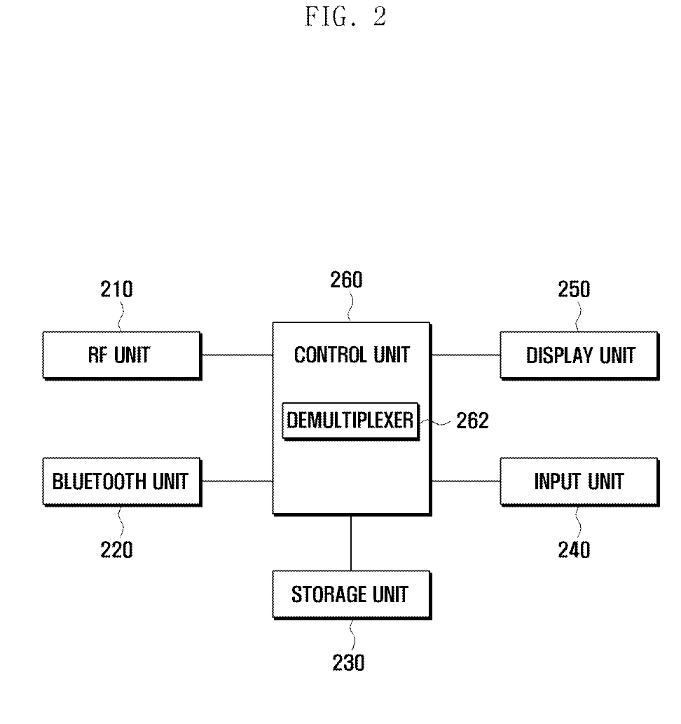

FIG. 2 is a block diagram illustrating a configuration of a Bluetooth-enabled mobile device according to an exemplary embodiment of the present invention.

Referring to FIG. 2, the mobile device includes a Radio Frequency (RF) unit 210, a Bluetooth unit 220, a storage unit 230, an input unit 240, a display unit 250, and a control unit 260. The control unit 260 includes a demultiplexer 262. The RF unit 210 is responsible for radio communication of the mobile device 100. The RF unit 210 may include an RF transmitter for up-converting and amplifying a transmission radio signal and an RF receiver for low noise amplifying and down-converting a received radio signal. The RF unit 210 delivers data carried by the received signal to the control unit 260 and transmits the data received from the control unit 260 in the form of a radio signal. In an exemplary implementation, the RF unit 210 is responsible for receiving multiplexed audio stream data over a radio channel. The multiplexed audio stream data may carry multiplex sound data or multichannel audio data (e.g., 5.1 channel audio).

The Bluetooth unit 220 provides a Bluetooth radio interface to establish Bluetooth links with other Bluetooth devices within transmission range. The Bluetooth unit 220 transfers inquiry response messages received from other Bluetooth devices to the control unit 260. The Bluetooth unit 220 also receives device identity information such as Bluetooth Device Address (BE_ADDR) and device class. In an exemplary implementation, the Bluetooth unit 220 is configured to establish Bluetooth links with other Bluetooth audio devices selected by the user. The Bluetooth unit 220 includes a Pulse Code Modulation (PCM) data buffer for storing audio data demultiplexed from a multiplexed audio data. The Bluetooth unit 220 may store the demultiplexed audio data in the PCM data buffer per channel. The Bluetooth unit 220 may also include a Smart Bitrate Control (SBC) encoder for encoding individual audio data stored in the PCM data buffer in an SBC format.

The storage unit 230 stores application programs and data for use by the mobile device and may be divided into a program region and a data region. In an exemplary implementation, the storage unit 230 may be implemented with at least one of volatile and non-volatile storage media. The volatile storage media include a Random Access Memory (RAM), a Dynamic Random Access Memory (DRAM), and a Static Random Access Memory (SRAM), and the like. The non-volatile memory includes a hard disk, a Flash NAND memory, and the like. In an exemplary implementation, the storage unit 230 may store device identity information (e.g. device address, device name, and device class) received from the Bluetooth audio devices. In a case where the mobile device 100 establishes Bluetooth channels with multiple Bluetooth audio devices, the storage unit 230 may store channel identity information for identifying the Bluetooth channels established with corresponding audio devices. The storage unit 230 may also temporarily store the audio data temporarily received through the RF unit 210 and multimedia files containing audio data (e.g., video and MP3 files).

The input unit 240 receives a key signal input by the user and transfers the key signal to the control unit. The input unit 240 may be implemented with at least one of a keypad including a plurality of alphanumeric keys and navigation keys, a touchpad, and a touchscreen. In a case where the mobile device includes a sensing means such as an image sensor and an acceleration sensor, these sensors may be included in the input unit 240. In an exemplary implementation, the input unit 240 may be configured such that the user may input a command for selecting one of the individual audio data demultiplexed from a multiplexed audio data. The input unit 240 may be configured such that the user may input a command for selecting one of multiple Bluetooth devices to deliver an audio data stream demultiplexed from the multiplexed audio data. The input unit 240 transfers the signal input by the user to the control unit 260.

The display unit 250 may be implemented with a Liquid Crystal Display (LCD) and provide the user with menus, input data, function settings, other information, and the like. For example, the display unit 250 is configured to display a booting screen, an idle mode screen, an indication information screen, a call progress screen, an application execution screen, and the like. In an exemplary implementation, the display unit 250 may display device addresses and names of the Bluetooth devices in a transmission range that are received in response to the inquiry message transmitted by means of the Bluetooth unit 220 under the control of the control unit 260. The display unit 250 may also display a list of the audio streams that are demultiplexed, by the demultiplexer 262, from the multiplexed audio data. The display unit 250 may display a list of the Bluetooth audio devices to which the Bluetooth channels are established by means of the Bluetooth unit 220. The Bluetooth audio device list includes the device names and addresses of the Bluetooth audio devices.

The control unit 260 controls overall operations of the mobile device and signaling among internal function blocks of the mobile device. In an exemplary implementation, the control unit 260 includes the demultiplexer 262 for demultiplexing the multiplexed audio data into individual audio streams. The control unit 260 controls the Bluetooth unit 220 to establish connections with multiple Bluetooth devices. The control unit 260 controls such that the multiplexed audio data stream or the media file in a multiplexed audio format received through the RF unit 210 is input to the demultiplexer 262. The demultiplexer 262 filters the multiplexed audio data and outputs the filtered individual audio data streams. The control unit 260 assigns Bluetooth channels established with multiple audio devices for the individual audio data streams, respectively. The control unit 260 also controls the Bluetooth unit 220 to transmit the individual audio streams to the audio devices through corresponding Bluetooth channels. The control unit 260 controls the display unit 250 to display a list of the individual audio data streams demultiplexed from the multiplexed audio data and the list of the audio devices connected the Bluetooth channels. The control unit 260 may also control the Bluetooth unit 220 to store the demultiplexed audio data streams in the PCM data buffer. The control unit 260 also controls the SBC encoder of the Bluetooth unit 220 to encode the individual audio data stream stored in the PCM data buffer in the SBC format.

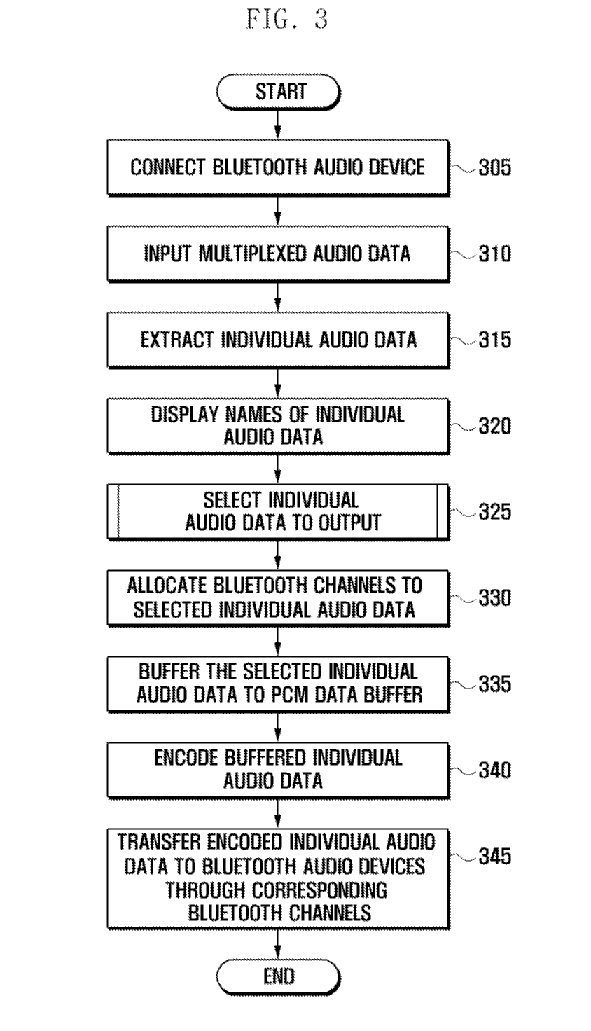

FIG. 3 is a flowchart illustrating a multichannel audio deliver method for a mobile device in a short range wireless communication network according to an exemplary embodiment of the present invention.

Referring to FIG. 3, in step 305 the control unit 260 of the mobile device controls the Bluetooth unit 220 to establish connections with a plurality of Bluetooth devices. In more detail, the control unit 260 controls the Bluetooth unit 220 to broadcast an inquiry signal and receive device addresses from the Bluetooth audio devices in response to the inquiry signal within the transmission range. Next, the control unit 260 controls the Bluetooth unit 220 to transmit a device name request signal to the Bluetooth audio devices that replied to the inquiry signal and receive the device names from the Bluetooth audio devices. Next, the control unit 260 controls the display unit 250 to display a list of the received device names such that the user may select one of the devices listed in the list. The display unit 250 may display the addresses and/or classes of the devices along with the device names under the control of the control unit 260.

If a device selection command is input through the input unit 240, the control unit 260 control the Bluetooth unit 220 to perform a paging process. In the paging process, the mobile device establishes communication channels with the Bluetooth audio devices that transmitted the inquiry response signal (including device address and clock information). The control unit 260 controls the Bluetooth unit 220 to transmit the paging signal containing a device address (BD_ADDR) and clock information of the mobile device to the Bluetooth audio devices. The Bluetooth audio device that received the paging signal transmits a paging response signal containing a Device Access Code (DAC) to the mobile device. The control unit 260 controls the Bluetooth unit 220 to receive the paging response signals transmitted by the Bluetooth audio devices and establish communication channels with the Bluetooth audio devices. Through the paging process, the mobile device is connected to respective Bluetooth audio devices. In an exemplary implementation, the Bluetooth audio devices may transmit Bluetooth channel IDentifiers (IDs) to the mobile device. The Bluetooth channel IDs include information for identifying a Bluetooth channel established between the mobile device and individual Bluetooth audio devices. The Bluetooth channel IDs may be stored in corresponding Bluetooth audio devices. The control unit 260 may identify the Bluetooth channels established with the individual Bluetooth audio devices based on the Bluetooth channel IDs.

In step 310, once the Bluetooth audio devices are connected to the mobile device, the control unit 260 of the mobile device receives multiplexed audio data. In an exemplary implementation, the control unit 260 may control the RF unit 210 to input the multiplexed audio data received through a radio channel. The control unit 260 may also receive the multiplexed audio data extracted from a media file stored in an audio data format. The multiplexed audio data is obtained by multiplexing a plurality of audio data.

The control unit 260 transfers the received multiplexed audio data to the demultiplexer. In an exemplary implementation, the demultiplexer 262 may be integrated into the control unit 260 or implemented independently. In step 315, the demultiplexer 262 demultiplexes the multiplexed audio data into individual audio data. The demultiplexer 262 performs filtering and demultiplexing on the multiplexed audio data to extract the individual audio data. Each individual audio data includes header information containing a name of corresponding audio data. In an exemplary implementation, the demultiplexer 262 may identify individual audio data using the header information. The demultiplexer 262 transfers the extracted individual audio data to the control unit 260.

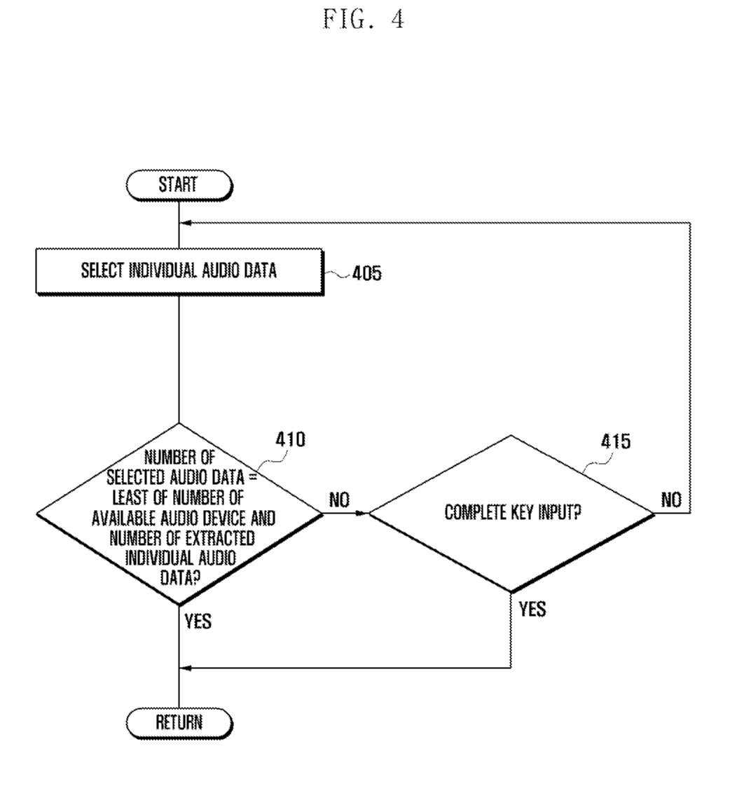

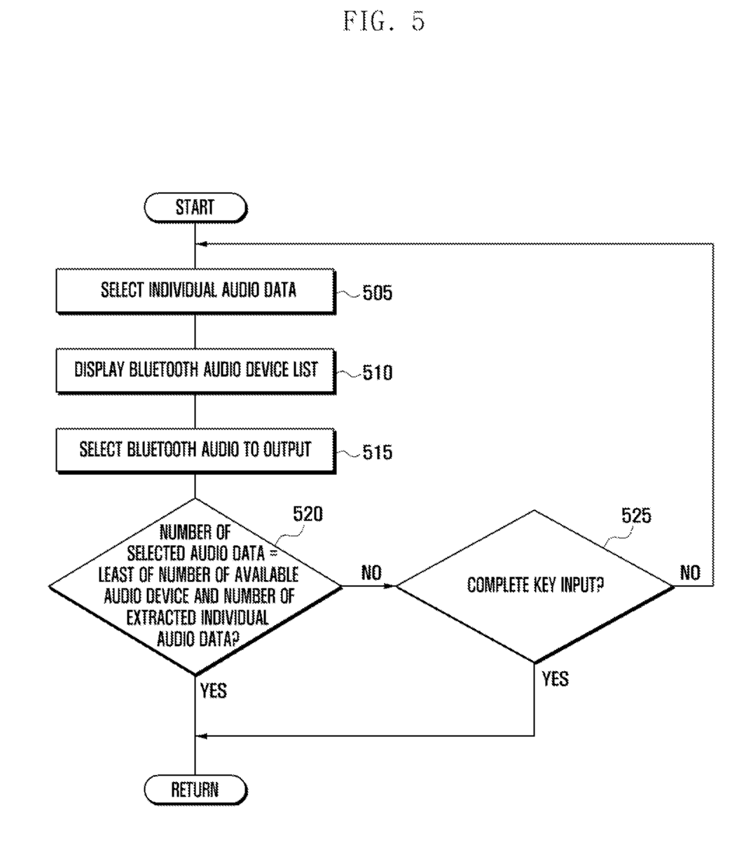

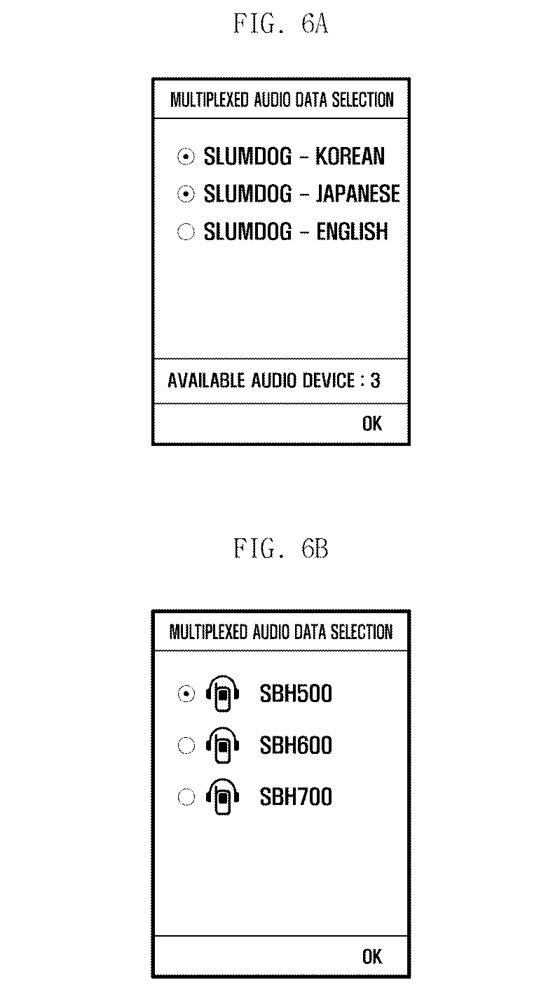

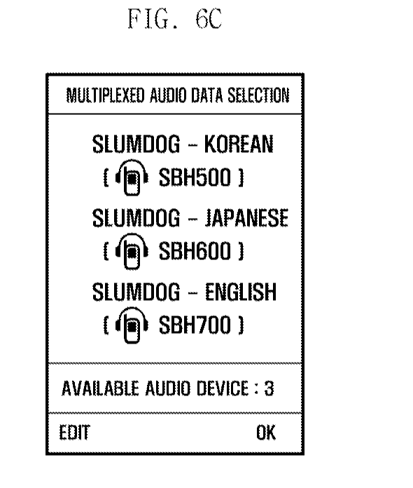

In step 320, the control unit 260 receives the individual audio data demultiplexed by the demultiplexer 262 and controls the display unit 250 to display the names of the individual audio data. FIG. 6A is a diagram illustrating a screen displaying a name list of individual audio data according to an exemplary embodiment of the present invention. As illustrated in FIG. 6A, three individual audio data are respectively named ‘Slumdog—Korean’, ‘Slumdog—Japanese’, and ‘Slumdog—English’ on the screen. In step 325, the control unit 260 controls the display unit 250 to display an individual audio data selection menu, and controls the input unit 240 to determine an audio data selection command input by the user. In an exemplary implementation, the control unit 260 may control such that the information on the number of the Bluetooth audio devices available for audio delivery is displayed along with the individual audio data selection menu. In FIG. 6A, the number of the available Bluetooth audio devices is set to 3. The available Bluetooth audio devices are the devices connected to the mobile device. In an exemplary implementation, the user may select only the individual audio data or both the individual audio data and available Bluetooth audio devices. The procedure for selecting the individual audio data is described with reference to FIGS. 4 and 5.

FIG. 4 is a flowchart illustrating an individual audio data selection process of FIG. 3 according to an exemplary embodiment of the present invention.

Referring to FIG. 4, in step 405, the control unit 260 first controls input unit 240 to determine a selection command input by the user. The user may select at least one of a plurality of individual audio data extracted from the multiplexed audio data. In FIG. 6, two individual audio data (e.g., Slumdog—Korean and Slumdog—Japanese) among the three individual audio data (e.g., Slumdog—Korean, Slumdog—Japanese, and Slumdog—English) are selected. In an exemplary implementation, the control unit 260 controls the display unit 250 to display the information on the number of audio devices available for delivering the individual audio data along with the individual audio data list. For example, if three Bluetooth devices are connected to the mobile device, the number of Bluetooth audio devices available for audio delivery is 3. Thus, the control unit 260 controls the display unit 250 to display “3” as the number of the available Bluetooth audio device.

Once the individual audio data and Bluetooth audio device selection have been completed, in step 410, the control unit 260 determines whether the number of the selected individual audio data is equal to the least of the number of the available Bluetooth devices and the number of extracted individual audio data. In more detail, if it is determined that the number of the individual audio data extracted in step 315 is greater than the number of the available Bluetooth audio devices, the control unit 260 determines whether the number of selected individual audio data is equal to the number of the available Bluetooth audio devices. If it is determined that the number of the individual audio data extracted in step 315 is less than the number of the available Bluetooth audio devices, the control unit 260 determines whether the number of the selected individual audio data is equal to the number of the total number of extracted individual audio data. If it is determined that the number of the selected individual audio data is equal to the least of the number of the available Bluetooth devices and the number of extracted individual audio data in step 410, the control unit 260 returns to step 330 of FIG. 3. This means that the user selects the number of the individual audio data as many as possible. In this case, the control unit 260 returns to step 330 regardless of the user input for completing individual audio data selection.

Otherwise, if it is determined that the number of the selected individual audio data is not equal to the least of the number of the available Bluetooth devices and the number of extracted individual audio data in step 410, the control unit 260 controls the input unit 240 to determine a selection complete command input by the user in step 415. If the user intends to output some but not all the individual audio data extracted from the multiplexed audio data, the control unit 260 returns to step 405 and controls the input unit 240 to determine the individual audio data selected by the user. For example, if it is determined that the number of the extracted individual audio data is 3, the number of the available Bluetooth audio devices is 3, the user selects the individual audio data, the control unit 260 determines whether the number of the selected individual audio data is 3. If the user selects all of the three individual audio data (e.g., Slumdog—Korean, Slumdog—Japanese, and Slumdog—English), the control unit 260 returns to step 330 of FIG. 3. However, if it is determined that the user selects one or two of the three individual audio data and if the selection complete command is input, the control unit 260 returns to step 330 of FIG. 3.

FIG. 5 is a flowchart illustrating an individual audio data selection process of FIG. 3 according to an exemplary embodiment of the present invention.

Referring to FIG. 5, in step 505, the control unit 260 controls the input unit 240 to determine a selection command input by the user. Once the individual audio data and Bluetooth audio device selection have been completed in step 505, the control unit 260 controls the display unit 250 to display a Bluetooth audio device list in step 510. In an exemplary implementation, the control unit 260 controls the display unit 250 to display the Bluetooth audio device list with device names of the available Bluetooth audio devices. FIG. 6B is a diagram illustrating an exemplary screen displaying a name list of the Bluetooth audio devices according to an exemplary embodiment of the present invention. As illustrated in FIG. 6B, three Bluetooth audio devices respectively named ‘SBH500’, ‘SBH600’, and ‘SBH700’ are listed on the screen. The Bluetooth audio devices are connected to the mobile device.

In step 515, the control unit 260 controls the input unit 240 to determine a device selection command input by the user. The user selects the Bluetooth audio device to deliver the individual audio data, and the control unit 260 determines the device selection command by means of the input unit 240 and matches the selected Bluetooth audio device with the individual audio data selected in step 505. In step 520, the control unit 260 determines whether the number of selected individual audio data is equal to the least of the number of the available Bluetooth devices and the number of extracted individual audio data. In more detail, if it is determined that the number of the individual audio data extracted in step 315 is greater than the number of the available Bluetooth audio devices, the control unit 260 determines whether the number of selected individual audio data is equal to the number of the available Bluetooth audio devices. However, if it is determined that the number of the individual audio data extracted in step 315 is less than the number of the available Bluetooth audio devices, the control unit 260 determines whether the number of the selected individual audio data is equal to the number of the total number of extracted individual audio data. If the number of the selected individual audio data is equal to the least of the number of the available Bluetooth devices and the number of extracted individual audio data in step 520, the control unit 260 returns to step 330 of FIG. 3. This means that the user selects the number of the individual audio data as many as possible. In this case, the control unit 260 returns to step 330 regardless of the user input for completing individual audio data selection.

Otherwise, if it is determined that the number of the selected individual audio data is not equal to the least of the number of the available Bluetooth devices and the number of extracted individual audio data in step 520, the control unit 260 controls the input unit 240 to determine a selection complete command that is input by the user in step 525. If it is determined that a selection complete command is input, the control unit returns to step 330 of FIG. 3. Otherwise, if it is determined that a selection complete command is not input, the control unit 260 controls the display unit 250 to display the individual audio data list and returns to step 505. Unlike in FIG. 4, the individual audio selection process in FIG. 5 allows designating the Bluetooth audio device for each individual audio data selected by the user.

The control unit 260 allocates the Bluetooth channels to the selected individual audio data in step 330 of FIG. 3. In FIG. 4, the Bluetooth channel allocation order is preset, and the control unit 260 allocates the Bluetooth channels in the preset allocation order. In an exemplary implementation, the Bluetooth channel allocation order may be determined according to the times when the Bluetooth audio devices have been connected to the mobile device or the Bluetooth audio devices have transmitted the inquiry response messages. In FIG. 5, the control unit 260 allocates the Bluetooth channel selected by the user to the individual audio data selected by the user. Referring to FIGS. 6A and 6B, if the user selects the ‘Slumdog—Korean’ among the extracted individual audio data and then the ‘SBH500’ among the Bluetooth audio devices, the control unit 260 allocates the Bluetooth channel corresponding to the device ‘SBH500’ for the individual audio data ‘Slumdog—Korean’.

FIG. 6C is a diagram illustrating a screen displaying a list of an individual audio data-audio device mapping table according to an exemplary embodiment of the present invention.

Referring to FIG. 6C, the ‘Slumdog—Korean’ is allocated to the ‘SBH500’, the ‘Slumdog—Japanese’ to the ‘SBH600’, and the ‘Slumdog—English’ to the ‘SBH700’. After allocating the individual audio data to the corresponding Bluetooth channels, the control unit 260 controls the display unit 250 to display the allocation result to the user. The user may change the Bluetooth audio device to output each individual audio data by manipulating an ‘edit’ key. That is, the user may change the Bluetooth channel for delivering the individual audio data by inputting a channel change command using the edit key.

The control unit 260 controls such that the selected individual audio data are stored in a PCM data buffer of the Bluetooth unit 220. In an exemplary implementation, the PCM data buffer is provided with a plurality of regions designated for the respective Bluetooth channels. Referring back to FIG. 3, in step 335, the control unit 260 allocates the regions of the PCM data buffer to the corresponding Bluetooth channel for storing the individual audio data allocated to the corresponding Bluetooth channels.

In step 340, the control unit 260 encodes the individual audio data stored in the PCM buffer in an SBC format. The SBC encoding is a method for encoding data at a variable rate according to the speed of a stream. After encoding the individual audio data, in step 345, the control unit 260 controls the Bluetooth unit 220 to transfer the encoded individual audio data to respective Bluetooth audio devices through corresponding Bluetooth channels. Each Bluetooth audio device receives the encoded individual audio data transmitted by the mobile device, decodes the received individual audio data, and outputs the decoded individual audio data by means of a receiver.

In an exemplary implementation, once the demultiplexer 262 analyzes the multiplexed audio data and demultiplexes the multiplexed audio data into multiple individual audio data in step 315, the control unit 260 may allocate the demultiplexed individual audio data to the Bluetooth channels in step 330 without performing step 320 and step 325. In step 330, the control unit 260 may allocate the individual audio data to the Bluetooth channels in a preset allocation order of Bluetooth channels when the number of the demultiplexed individual audio data is less than the number of the Bluetooth audio devices connected to the mobile device or in a preset allocation order of individual audio data when the number of the demultiplexed individual audio data is greater than the number of the Bluetooth audio devices connected to the mobile device. Thereafter, the control unit 260 performs steps 335 to 345.

The multichannel audio delivery method and system of exemplary embodiments of the present invention demultiplex a multiplexed audio data into multiple individual audio data and deliver the individual audio data to different Bluetooth audio devices through corresponding Bluetooth channels. Accordingly, a user can selectively output at least one of individual audio stream constituting a multiplex sound file or multiple individual audio streams constituting a multiplexed audio data to achieve a stereophonic feeling.

As described above, the multichannel audio delivery method and system of exemplary embodiments of the present invention delivers multiple audio streams constituting multiplexed audio data to different audio devices through short range wireless communication channels established with a source device. Thereby, at least one of the multiple audio streams is output through a single device or respective audio streams are output through different audio devices.

While the invention has been shown and described with reference to certain exemplary embodiments thereof, it will be understood by those skilled in the art that various changes in form and details may be made therein without departing from the spirit and scope of the invention, as defined by the appended claims and their equivalents.

What is claimed is:

1. An audio data delivery method for a mobile device in a short range wireless communication network, the method comprising:
establishing a communication channel with each of at least one audio device;
receiving multiplexed audio data;
extracting individual audio streams from the multiplexed audio data;
allocating at least one of the individual audio streams to one or more communication channels; and
transmitting the at least one of the individual audio streams to one or more of the at least one audio device through respective one or more communication channels.

2. The method of claim 1, wherein the allocating of the at least one of the individual audio streams:
displaying a list of the extracted individual audio streams;
selecting the at least one of the individual audio streams from the list; and
mapping the selected at least one of the individual audio streams to the one or more corresponding communication channels.

3. The method of claim 1, wherein the allocating of the at least one of the individual audio streams:
displaying an audio list comprising the extracted individual audio streams;
displaying, if the at least one of the individual audio streams is selected, a device list having the at least one audio device; and
mapping, if one or more of the at least one audio device is selected from the device list, the selected at least one of the individual audio streams to the selected one or more of the at least one audio device.

4. The method of claim 1, further comprising buffering the extracted individual audio streams to a Pulse Code Modulation (PCM) data buffer per communication channel.

5. The method of claim 4, further comprising encoding the individual audio streams buffered in the PCM data buffer in a Smart Bitrate Control (SBC) format.

6. A mobile device comprising:
a short range wireless communication unit for establishing a radio channel with each of at least one audio device;
a demultiplexer for demultiplexing multiplexed audio data into individual audio streams; and
a control unit for allocating at least one of the individual audio streams to one or more radio channels and for transmitting the at least one of the individual audio streams to one or more of the at least one audio device through corresponding one or more radio channels.

7. The mobile device of claim 6, wherein the short range wireless communication unit comprises a Pulse Code Modulation (PCM) data buffer for buffering the at least one individual audio stream.

8. The mobile device of claim 6, wherein the short range wireless communication unit comprises an encoder for encoding the at least one individual audio stream in a Smart Bitrate Control (SBC) format.

9. The mobile device of claim 6, further comprising:
a display unit for displaying a list of the demultiplexed individual audio streams; and
an input unit for generating a selection command for selecting the at least one of the individual audio streams from the list,
wherein the control unit maps the selected at least one of the individual audio streams to the one or more corresponding radio channels.

10. The mobile device of claim 6, further comprising:
a display unit for displaying a list of the demultiplexed individual audio streams and a list of the at least one audio device connected to the mobile device; and
an input unit for generating a selection command for selecting the at least one of the individual audio streams from the audio stream list and one or more of the at least one audio device from the device list,
wherein the control unit maps the selected at least one of the individual audio streams to the selected one or more of the at least one audio device.

11. An audio data delivery method for a mobile device in a short range wireless communication network, the method comprising:
establishing a communication channel with each of at least one audio device;
receiving multiplexed audio data;
demultiplexing the multiplexed audio data into individual audio streams;
allocating at least one of the individual audio streams to one or more communication channels; and
transmitting the at least one of the individual audio streams to one or more of the at least one audio device through corresponding one or more communication channels.

12. The method of claim 11, wherein the allocating of the at least one of the individual audio streams comprises displaying at least one of a list of the demultiplexed individual audio streams and an audio list comprising the demultiplexed individual audio streams.

13. The method of claim 12, wherein the allocating of the at least one of the individual audio streams comprises determining a selection input command for at least one of selecting the at least one of the demultiplexed individual audio streams from the list and selecting of one or more of the at least one audio device from the device list.

14. The method of claim 13, wherein the allocating of the communication channels comprises displaying, if the at least one of the demultiplexed individual audio streams is selected, a device list having the at least one audio device.

15. The method of claim 14, wherein the allocating of the communication channel comprises at least one of mapping the selected at least one of the individual audio streams to the one or more corresponding communication channel and mapping, if one or more of the at least one audio device is selected from the device list, the selected at least one of the individual audio streams to the selected one or more of the at least one audio device.

16. The method of claim 11, further comprising buffering the extracted individual audio streams to a Pulse Code Modulation (PCM) data buffer per communication channel.

17. The method of claim 16, further comprising encoding the individual audio streams buffered in the PCM data buffer in a Smart Bitrate Control (SBC) format.
